(19) United States
(12) Patent Application Publication
(10) Pub. No.: US 2009/0101370 A1
(43) Pub. Date: Apr. 23, 2009

(54) Soil transport surface with anti-adhesion biomimetic features and machine using same

(75) Inventor: Vasil Tasovski, Peoria, IL (US)

Correspondence Address: CATERPILLAR c/o LIELL, MCNEIL & HARPER, P.O. BOX 2417, 511 SOUTH MADISON STREET, BLOOMINGTON, IN, 47402-2417, US

(73) Assignee: Caterpillar Inc.

(21) Appl. No.: 11/975,190

(22) Filed: Oct. 18, 2007

(51) Int. Cl. A01B 79/00

(52) U.S. Cl. 172/1; 172/133

(57) ABSTRACT

A soil transport machine, such as a track type tractor equipped with a bulldozer blade, includes a soil transport interaction surface (blade) with an array of anti-adhesion biomimetic protrusions that project out of a base surface. The biomimetic protrusions may have a smooth convex shape sized and distributed in a manner that reduces soil adhesion and the associated carryback, especially in adhesive soils such as heavy clay. The biomimetic protrusions may be incorporated directly into the surface of the bulldozer blade, or maybe part of a replaceable liner that is attached to the blade body in a conventional manner.

### TECHNICAL FIELD

The present disclosure relates generally to machines that facilitate soil transport, and more particularly to a soil transport interaction surface with an array of biomimetic protrusions to inhibit soil adhesion.

### BACKGROUND

Soil adhesion and the associated carryback often occur when soil transport machines interact with soil. The adhesion of soil to the soil transport interaction surfaces results in a phenomenon commonly referred to as carryback, which increases the working resistance and energy consumption of the machine, and in many instances decreases work quality. Performances of excavator buckets, bulldozer blades, and self unloading boxes of dump trucks are known to decrease by 30-50% due to carryback alone when working with certain adhesive soil types. Although most soil transport interaction surfaces include corners, edges and other surface features inherent in their manufacture, they are for the most part smooth surfaces. While soil adhesion and the associated carryback are often not significant concerns in many soil types, such as friable soil, soil adhesion and the associated carryback can drastically reduce efficiency in other soil types, such as heavy clay soil. Thus, the efficiency of a particular soil transport machine can swing between relative extremes depending upon the soil type encountered in a particular location and duty cycle.

Problems associated with soil adhesion and carryback have long been recognized in the art, and a variety of solutions have been tried. For instance, U.S. Pat. No. 5,601,325 teaches the inclusion of multiple apertures over 50-80% of a shovel blade surface in order to inhibit soil adhesion. Others have attempted to solve soil adhesion problems using means of electro-osmosis, vibration mechanisms, lubrication strategies, and even a variety of polymer and enamel coatings on soil interaction surfaces. But none of these have proven commercially viable.

Soil adhesion has also been recognized as a problem in the related technology field involving tillage equipment. Tilling is to be contrasted with soil transport in that tillage involves working soil without transport at a location via turning the soil, such as with a plow, and cultivating or braking up the soil to better facilitate the growing of crops. Researchers at Jilin University in China have reported some success with biomimetic engineering strategies as applied to plows. Biomimetic refers to the concept of mimicking an observed problem/solution phenomenon in nature in the design of a man made object. For instance, the hook and loop fasteners commonly known by the trade name Velcro utilized biomimetic techniques to create a fastener by observing the structure of certain seeds in nature that include a hook like appendage that grasps onto clothing or animal fur. This plant strategy can facilitate carrying the seed away from the parent plant. Another example might be a rice scoop with a textured surface that seems to inhibit rice from sticking to the scoop. In the case of the Jilin University study, the researchers identify surface textures of various soil burrowing insects to arrive at a modified plow blade surface. In particular, certain dung beetles include textured surfaces that apparently help prevent adhesion of soil. The result of the research produced an applied bionic plow mold board with a non-smooth surface. In particular, the illustrated plow includes a plurality of convex bumps distributed over about 5% of the plow surface. The bumps are distributed in a manner that takes into account the sheer direction of soil contact with the plow during plow motion. Although the Jilin University plow suggests that anti-adhesion insect strategies might have application is some tillage equipment, it provides little guidance in arriving at a biomimetic solution to soil adhesion in soil transport machines.

Thus, it appears that some of the problems associated with soil adhesion have been solved by some soil burrowing insects, such as the dung beetle, the ant, the mole cricket and likely others through geometrical textured surface morphologies on their exoskeleton soil contacting surfaces. These rough surface morphologies, which typically range on the order of 0.075-0.20 mm, apparently enable the animals to move freely through soil and prevents soil from adhering to their bodies. While all of these soil burrowing insect surface features are non-smooth, they vary substantially from one another. In addition, they give no clue as to how those surface features could be scaled in size, shape, density and other factors to address soil adhesion problems occurring in soil transport machines, such as excavators, bulldozers, dump trucks and the like.

The present disclosure is direct to one or more of the problems set forth above.

### SUMMARY OF THE DISCLOSURE

In one aspect, a machine includes a machine body with an implement assembly having a soil transport interaction surface. The soil transport interaction surface includes a base surface and an array of anti-adhesion biomimetic protrusions that project out of the base surface.

In another aspect, an implement includes an implement body with a coupler and a soil transport interaction surface. The soil transport interaction surface includes a base surface and an array of anti-adhesion biomimetic protrusions that project out of the base portion. The anti-adhesion biomimetic protrusions make up at least about 15% of the total area of the soil transport interaction surface.

In still another aspect, a method of transporting soil includes moving soil from a first location to a second location by moving a soil transport interaction surface. Adhesion of soil to the soil transport interaction surface is reduced by forcing soil to contact anti-adhesion biomimetic protrusions during the transporting step.

### BRIEF DESCRIPTION OF THE DRAWINGS

FIG. 1 is a perspective view of a machine according to one aspect of the present disclosure;

FIG. 2 is a schematic view of a bulldozer blade liner according to another aspect of the present disclosure;

FIG. 3 is a sectioned side view of an example biomimetic protrusion according to another aspect of the present disclosure;

FIG. 4 is a side view of a machine according to still another aspect of the present disclosure; and

FIG. 5 is a side view of a machine according to another aspect of the present disclosure.

### DETAILED DESCRIPTION

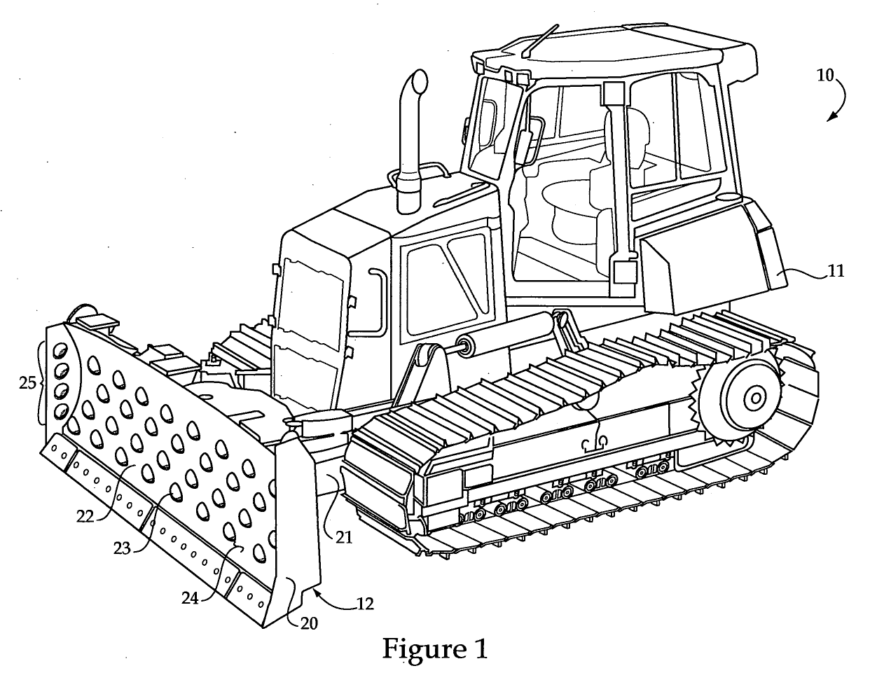

Referring to FIG. 1, the machine 10 which is illustrated as a track type tractor, includes a machine body 11 with an implement assembly 12 in the form of a bulldozer blade assembly. The bulldozer blade assembly 25 includes a bulldozer blade body 20 with couplers 21 that facilitate connection to machine body 11. Dozer blade body 20 also includes a soil transport interaction surface 22 with a relatively smooth base surface 24 and an array 25 of anti-adhesion biomimetic protrusions 23 that project out of base surface 24. Thus, except for the biomimetic protrusions 23, blade assembly 12 is substantially identical to prior art blade assemblies. In other words, base surface 24 in predominantly smooth but may include corners, edges, welds, bolt heads and the like. Thus, a base surface according to the present disclosure may be predominantly smooth, but will likely include various surface features relating to the implement construction and function. The pattern defined by the array of anti-adhesion biomimetic protrusions 23 may or may not include a repeating pattern. For instance, the array 25 shown in FIG. 1 shows the protrusions 23 distributed in an offset rows that define a repeating pattern. Nevertheless, those skilled in the art will appreciate that any predetermined pattern, whether repeating or not would fall within the intended scope of the present disclosure.

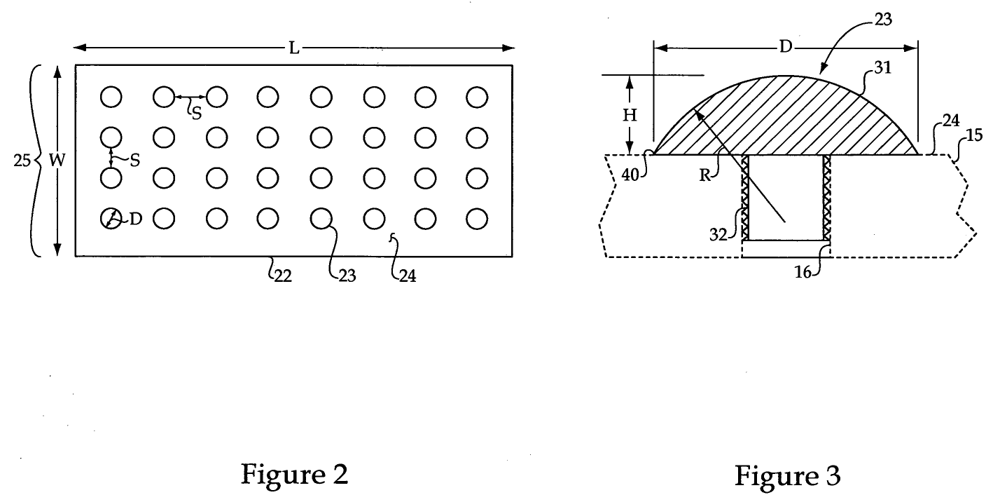

The biomimetic protrusions 23 may be attached to bulldozer blade body 20 in any suitable manner, such as via welding or a threaded attachment, or may be formed as part of a replaceable linear 15 as shown in FIG. 2. Those skilled in the art will appreciate that some bulldozer blade assembly manufacturers offer users an option of a replaceable wear liner when the machine is to be used in a heavily abrasive environment such as removing rocks. Thus, a liner 14 according to the present disclosure would offer a user another option for use when operating machine 10 in a relatively adhesive soil environment, such as clay. Line 15 includes couplers (not shown) that facilitate attachment to a dozer blade body 20 in a conventional manner, which may differ among different machine manufacturers. FIG. 2 is also useful in illustrating a number of design options available for arriving at an array 25 suitable for a given application. Some of the constraints include the blade having a fixed length L and a fixed width W. Assuming that the protrusions 23 are distributed in rows, a designer would have the option of choosing a number of protrusions along the length to mention L and a number of protrusions 23 distributed along the width dimension W. In addition, the size of the protrusions D, which relates to the fraction of the overall surface area (L×W) as well as the spacing S between protrusions 23 are all matters of design choice. In addition, FIG. 3 is useful in illustrating that another design choice available is the shape of the protrusion 23 as well as the height H that the protrusion protrudes out of the base surface 24.

Initial testing for an application of the present disclosure to a bulldozer blade assembly suggests that the biomimetic protrusions 23 might need to cover at least about 15% of the total surface area in order to realize a substantial benefit in performance. The term “about” means that when the number is rounded off to the requisite number of significant digits, the numbers are equal. For example, 14.5 is about 15. Testing also has revealed that the performance benefit from the anti-adhesion biomimetic protrusions 23 peaks in the range from 15% to about 30% of the total area of the soil interaction surface 22. Testing also suggests that the benefit gained is not significant when the biomimetic protrusions 23 cover in excess of 30% of the soil transport interaction surface 22. Nevertheless, the present disclosure contemplates instances where less than 15% of more than 30% of the soil interaction transport surface is covered by protrusion 23 according to the present disclosure. For instance, a different implement assembly that interacts with soil in manner different from a bulldozer blade assembly may call for a different percentage of biomimetic protrusions 23 than that percentage that performs best on a bulldozer blade in a certain type of soil. Although FIGS. 1 and 2 show the biomimetic protrusions 23 having a uniform diameter D, those skilled in the art will appreciate that the present disclosure also contemplates a single application with biomimetic protrusions having two or more different sizes and/or areas. For instance, further testing might reveal that different sizes and densities of biomimetic protrusion mixed together might work best on different locations of a soil interaction transport surface.

Referring now to FIG. 3, a sectioned view through one example biomimetic protrusion 23 is illustrated. In this example, the biomimetic protrusion 23 is a portion of sphere having a radius R that results in a smooth convex surface 31 to be contrasted with the relatively flat profile of the base surface 24 surrounding the protrusion 23. Those skilled in the art will appreciate that base surface 24 in the case of a bulldozer blade assembly 12 is relatively flat when viewed close up in the vicinity of a single protrusion 23, but when one pulls back, it becomes clear that the base surface 24 may have a concave shape. Thus, the present disclosure contemplates base surfaces that are planar, convex or concave on a large scale, but locally in the vicinity of a protrusion 23, the base surface 24 is relatively planar relative to the protrusion 23. In the example shown in FIG. 3, the biomimetic protrusion 23 may be characterized by a ratio of its diameter D to its height H that it protrudes above base surface 24. Initial testing suggests that the ratio of diameter D to height H should be in the range of about 3 to about 4 in order to achieve the best anti-adhesion performance in the case of a bulldozer blade assembly 12 operating in adhesive clay soil conditions. However, the present disclosure does contemplate ratios outside of this range, which may be more suitable for different implement assemblies interacting with different soil types. In addition, although the protrusion 23 is shown as a portion of a sphere, those skilled in the art will appreciate that other shapes would fall within the scope of the present disclosure. In addition, the shapes may be oblong and may be less than smooth, such as, for instance, faceted surfaces. Furthermore, the protrusion 23 may not be convex over its entire surface 31, but may include additional surface features on a different scale. For instance, the surface 31 may include irregularities including but not limited to a distribution of concave or convex dimpling over the surface 31 which when viewed as a whole would still be considered convex relative to base surface 24. FIG. 3 is also useful in illustrating some example attachment strategies to either a liner 15 or a bulldozer blade body. For instance, each biomimetic protrusion 23 may include an attached threaded stud 32 that could be threaded into a bore 16 defined by either the liner 15 or blade body 20. Alternatively, the threaded stud 32 could be eliminated and instead the protrusion 23 attached via welding, such as an annular weld at the interface 40 between the annular edge of protrusion 23 and base surface 24.

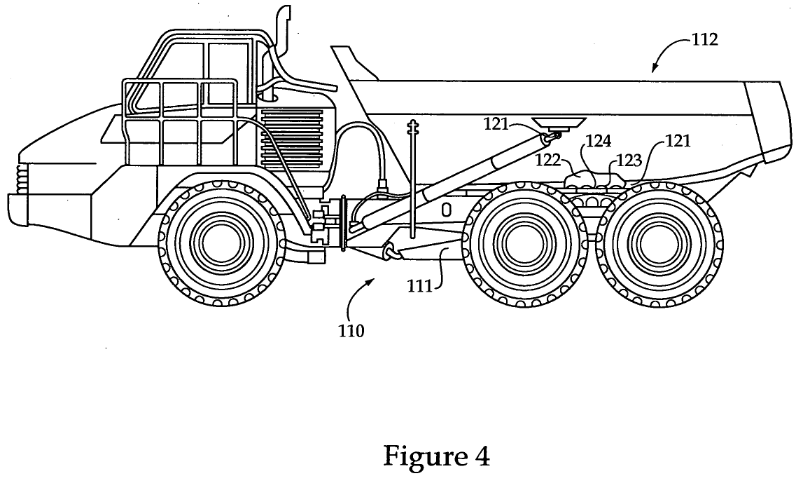

Referring now to FIG. 4, a machine 110 according to another embodiment of the present disclosure comprises a dump truck. Machine 110 includes a machine body 111 that includes a walled soil container 112 in the form of a dump truck bed. Dump truck bed 112 includes couplers 121 that facilitate its connection to machine body 111. In order to inhibit adhesion of soil to dump truck bed 112, an array of anti-adhesion biomimetic protrusions 123 are distributed over the soil transport interaction surface 122. Like the earlier embodiment, the biomimetic protrusions 123 project above a base surface 124. The biomimetic protrusions 123 may have a size and distribution similar to that shown with regard to the bulldozer blade assembly 12 discussed earlier. In addition, as opposed to being incorporated directly into dump truck bed 112, the protrusions 123 may be formed or attached to a replaceable linear of a type known in the art.

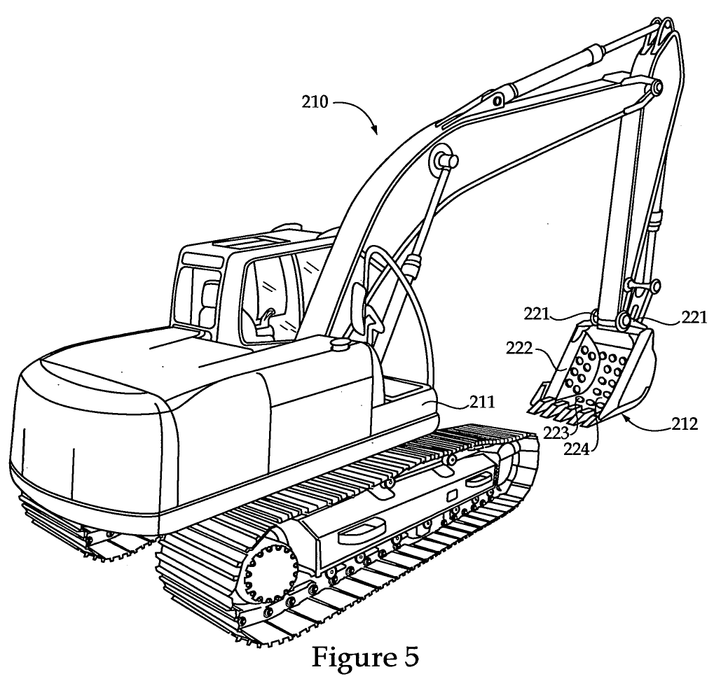

Referring now to FIG. 5, a machine 210 according to still another embodiment of the present disclosure is shown in the form of an excavator. A machine body 211 is attached to an excavator bucket 212 that includes a soil interaction transportation surface 222, which constitutes the inner surface of the bucket. Bucket 212, which may also be considered a walled soil container, also includes couplers 221 for connection to the stick of excavator 212. Like the previous embodiments, the soil interaction transportation surface 222 includes an array of anti-adhesion biomimetic protrusions 223 that are distributed about, and protrude from, a base surface 224.

### INDUSTRIAL APPLICABILITY

The present disclosure finds potential application to any machine that utilizes a soil transport interaction surface to move soil from a first location to a second location. Soil transport is to be contrasted with soil tillage in that it is carried from one location to another location via the action of the machine rather than turned over in place or broken up as in a tillage operation. Although the present disclosure has been illustrated in the context of several different soil transport machines including a track type tractor equipped with a bulldozer blade, a dump truck and an excavator, the present disclosure is not so limited. For instance, a loader bucket might benefit from the present disclosure when operating in certain soil types. The present disclosure also finds potential application in liners used in conjunction with machines that facilitate soil transport. For instance, soil transport is facilitated with a bulldozer blade by the machine capturing soil at a first location and pushing the soil to a second location by moving the soil transport interaction surface 22. When this occurs, the soil is forced into contact with the soil transport interaction surface 22 and consequently with the anti-adhesion biomimetic protrusions 23. In the case of a dump truck, the soil is transport from a first location to a second location by first being placed in the dump truck bed 112 and thereafter deposited at a second location when the dump truck lifts the bed and dumps the load as shown in FIG. 4. Soil transport is facilitated by the excavator of FIG. 5 by scooping of soil in a first location and dumping the soil at a second location, which may be at adjacent area near the excavator or a truck, such as dump truck 110 for transport to a remote location.

In all of these soil transport examples, the soil is forced into contact with the soil transport interaction surface 22, 122, 222, and by consequence with the anti-adhesion biomimetic protrusions 23, 123, 223. For reasons not completely understood, the protrusions 23, 123, 223 tend to lessen the ability of the soil to stick to both of the protrusions and the surrounding base surface 24, 124, 224. It is believed that protrusions 23, 123, 223 reduce adhesive contact between the soil and the portion of the base surface 24, 124, 224 surrounding the protrusions. A reduced contact sufficient to create adhesion reduces the overall soil-to-metal adhesion, and thus lessons the ability of the soil to stick to the soil transportation surface 22, 122, 222. When operating in adhesive soil, such as heavy clay soil, the improvement and performance of the relevant machine can be profound. For instance, in the case of a bulldozer blade, the payload can be increased from 10% to 42% or more by reducing soil adhesion and the associated carryback in heavy clay soil. There likely is a tradeoff with maybe up to 4% decrease in payload if the same soil transport interaction surface is used in less adhesive soil, such as friable soil. Thus, depending upon the expected duty cycle of the particular machine, it may be more advantageous to have the anti-adhesion biomimetic protrusions permanently attached to the relevant soil transportation interaction surface if the machine spends a substantial portion of its duty cycle operating in adhesive soil. On the other hand, if the machine only occasionally operates in adhesive soil, it may be more advantageous to utilize a removable liner equipped with anti-adhesion biomimetic protrusions so that the performance of the machine can be elevated when operating in adhesive soil, but not degraded when operating in less adhesive soil conditions.

It should be understood that the above description is intended for illustrative purposes only, and is not intended to limit the scope of the present disclosure in any way. For instance, those skilled in the art will appreciate that the anti-adhesions biomimetic protrusion strategy of the present disclosure might find potential application elsewhere in machines where there has been observed soil adhesion, possibly on non-work surfaces, that otherwise undermine the performance and efficiency of the machine. For example, the backside of a bulldozer blade assembly or the underside of an excavator bucket may benefit from the addition of anti-adhesion biomimetic protrusions according to the present disclosure. Thus, those skilled in the art will appreciate that other aspects of the disclosure can be obtained from a study of the drawings, the disclosure and the appended claims.

What is claimed is:

1. A machine comprising:
a machine body that includes an implement assembly with a soil transport interaction surface; and
the soil transport interaction surface including a base surface and an array of anti-adhesion biomimetic protrusions that project out of the base surface.

2. The machine of claim 1 wherein the implement assembly includes a replaceable liner attached to an implement base unit; and
the base surface and the anti-adhesion biomimetic protrusions are parts of the liner.

3. The machine of claim 2 wherein the implement assembly is a bulldozer blade assembly.

4. The machine of claim 2 wherein the implement is a walled soil container.

5. The machine of claim 4 wherein the walled soil container includes a dump truck bed.

6. The machine of claim 1 wherein the implement assembly is an excavator bucket.

7. The machine of claim 1 wherein the implement assembly is a bulldozer blade assembly.

8. The machine of claim 1 wherein the implement assembly includes a dump truck bed.

9. The machine of claim 1 wherein the anti-adhesion biomimetic protrusions are identical; and
the array includes a repeating pattern.

10. An implement comprising:
an implement body including a coupler and a soil transport interaction surface;
the soil transport interaction surface including a base surface and an array an anti-adhesion biomimetic protrusions that project out of the base surface; and
the anti-adhesion biomimetic protrusions making up at least about fifteen percent of a total area of the soil transport interaction surface.

11. The implement of claim 10 wherein the implement body is a liner for an implement assembly.

12. The implement of claim 10 wherein each of the anti-adhesion biomimetic protrusions includes an exposed smooth convex surface.

13. The implement of claim 12 wherein the smooth convex surface is a portion of a sphere.

14. The implement of claim 10 wherein the anti-adhesion biomimetic protrusions make up a range of about fifteen to thirty percent of a total area of the soil transport interaction surface.

15. The implement of claim 10 wherein each of the anti-adhesion biomimetic protrusions has a height to width ratio in a range from about three to about four.

16. The implement of claim 10 wherein the implement body is a bulldozer blade body.

17. A method of transporting soil comprising the steps of:
transporting soil from a first location to a second location by moving a soil transport interaction surface;
reducing adhesion of soil to the soil transport interaction surface by forcing soil to contact anti-adhesion biomimetic protrusions during the transporting step.

18. The method of claim 17 wherein the reducing step includes forming the anti-adhesion biomimetic surfaces to have a smooth convex shape, distributing the anti-adhesion biomimetic surfaces in an array across the soil transport interaction surface, and sizing the anti-adhesion biomimetic surfaces to make up at least about fifteen percent of a total area of the soil interaction transport surface.

19. The method of claim 18 including a step of attaching a liner that includes the anti-adhesion biomimetic surfaces to an implement body.

20. The method of claim 17 wherein the transporting step includes pushing soil with a bulldozer blade assembly.
